(19) United States
(12) Patent Application Publication
(10) Pub. No.: US 2014/0198363 A1
(43) Pub. Date: Jul. 17, 2014

(54) METHOD FOR GENERATING A POINT LIGHT SOURCE IN A PLANE AT AN ARBITRARY LOCATION USING A DYNAMIC HOLOGRAM

(71) Applicant: QUALCOMM MEMS TECHNOLOGIES, INC., San Diego, CA (US)

(72) Inventors: Chung-Po Huang, San Jose, CA (US); Russell Wayne Gruhlke, Milpitas, CA (US)

(73) Assignee: QUALCOMM MEMS TECHNOLOGIES, INC., San Diego, CA (US)

(21) Appl. No.: 13/744,188

(22) Filed: Jan. 17, 2013

(51) Int. Cl. G03H 1/22

(52) U.S. Cl. CPC G03H 1/22
USPC 359/22

(57) ABSTRACT

This disclosure provides systems, methods and apparatus, including computer programs encoded on computer storage media, for providing a display device. In one aspect, the display device may include a light source system, a programmable hologram system, a light-turning layer and a control system. A control system may control the programmable hologram system to generate a sequence of holographic images of point light sources. The control system may control the programmable hologram system according to software stored in a non-transitory medium. By scanning a sequence of holographic images of point light sources across the light-turning layer, a frame of image data can be reproduced on the display device.

### TECHNICAL FIELD

This disclosure relates generally to display devices.

### DESCRIPTION OF THE RELATED TECHNOLOGY

Forming bright spots at desired locations in a display plane is a basic function of various types of displays. Common methods of generating such bright spots include pixel switches, such as liquid crystal displays (LCDs), which allow light emitted by a back light to pass through pixels at desired locations. Some displays, such as organic light-emitting diode (OLED) displays, are configured to emit light from the display plane. Projection displays project light to form image pixels of a display plane. Although all of these displays can provide satisfactory performance for certain types of applications, it would be desirable to provide novel and improved display devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in display device that includes a light source system having a first light source configured for producing light of a first color, a light-turning layer; a programmable hologram system and a control system. The programmable hologram system may include a first programmable hologram disposed proximate the light source system and the light-turning layer so as to be capable of forming a first holographic light source image of the first color in the light-turning layer. The control system may be configured to control the programmable hologram system and the light source system to form the first holographic light source image of the first color within the light-turning layer.

In some implementations, the control system may be configured to control the programmable hologram system and the light source system to generate a sequence of holographic point light source images and/or a sequence of holographic line light source images. The control system may be configured to control the programmable hologram system and the light source system to generate a sequence of holographic area light source images within the light-turning layer.

The light source system may include a second light source configured for producing light of a second color and a third light source configured for producing light of a third color. The control system may be further configured to control the first programmable hologram to form a second holographic light source image of the second color within the light-turning layer and to control the first programmable hologram to form third holographic light source image of the third color within the light-turning layer.

The programmable hologram system also may include a second programmable hologram proximate the second light source and the light-turning layer and a third programmable hologram proximate the third light source and the light-turning layer. The control system may be further configured to control the second programmable hologram and the second light source to form a second holographic light source image of the second color within the light-turning layer and to control the third programmable hologram and the third light source to form a third holographic light source image of the third color within the light-turning layer.

In some implementations, the control system may be further configured to form the first, second and third holographic light source images in substantially the same area of the light-turning layer at substantially the same time. The control system may be further configured to form a frame of image data by scanning a sequence of holographic light source images across the light-turning layer. In some implementations, the control system may be further configured to control the first, second and third light sources and the programmable hologram system according to a field-sequential color method.

The light source system also may include a fourth light source configured for producing light of a fourth color. The control system may be further configured to control the first programmable hologram to form fourth holographic light source images of the fourth color within the light-turning layer. The programmable hologram system also may include a second programmable hologram proximate the second light source and the light-turning layer, a third programmable hologram proximate the third light source and the light-turning layer and a fourth programmable hologram proximate the fourth light source and the light-turning layer.

The control system may be further configured to control the second programmable hologram and the second light source to form a second holographic light source image of the second color within the light-turning layer. The control system may be further configured to control the third programmable hologram and the third light source to form a third holographic light source image of the third color within the light-turning layer. The control system may be further configured to control the fourth programmable hologram and the fourth light source to form fourth holographic light source images of the fourth color within the light-turning layer.

In some implementations, the light-turning layer may include a plurality of light-turning elements. The light-turning elements may include facets, frusta, light-scattering dots, or diffractive elements. In some implementations, a light extraction efficiency of the light-turning elements may increase with increasing distance from the first light source.

In some implementations, the display device also may include a memory device that is configured to communicate with the control system. The control system may include a processor that is configured to process image data. The display device also may include an image source module configured to send the image data to the processor. The image source module may include a receiver, a transceiver and/or a transmitter. The display device also may include an input device configured to receive input data and to communicate the input data to the processor.

Another innovative aspect of the subject matter described in this disclosure can be implemented in a method for controlling a display device. The method may involve controlling a programmable hologram system and a light source system to form a first holographic light source image of a first color at a first location of a light-turning layer. The method may involve changing a pattern on the programmable hologram system to form another first holographic light source image of the first color at a second location of the light-turning layer.

The method may involve controlling the programmable hologram system and the light source system to form a second holographic light source image of a second color at the first location of the light-turning layer. The method may involve controlling the programmable hologram system and the light source system to form a third holographic light source image of a third color at the first location of the light-turning layer.

The controlling processes may involve forming the first, second and third holographic light source images at substantially the same time. However, in some implementations the controlling processes may involve forming the first, second and third holographic light source images in a time sequence. For example, the controlling processes involve forming the first, second and third holographic light source images according to a field-sequential color method. The method may involve forming a frame of image data by scanning a sequence of holographic light source images across the light-turning layer.

The controlling processes may involve controlling a first programmable hologram of the programmable hologram system to form the first holographic light source image of the first color, controlling a second programmable hologram of the programmable hologram system to form the second holographic light source image of the second color and controlling a third programmable hologram of the programmable hologram system to form the third holographic light source image of the third color. The method may involve controlling the programmable hologram system and the light source system to form a fourth holographic light source image of a fourth color at the first location of the light-turning layer.

Another innovative aspect of the subject matter described in this disclosure can be implemented in a non-transitory computer-readable medium having software coded thereon. The software may include instructions for controlling a display device to control a programmable hologram system and a light source system to form a first holographic light source image of a first color at a first location of a light-turning layer. The software may include instructions for controlling the display device to control the programmable hologram system and the light source system to form a second holographic light source image of a second color at a second location of the light-turning layer. The software may include instructions for controlling the display device to control the programmable hologram system and the light source system to form a third holographic light source image of a third color at a third location of the light-turning layer.

In some implementations, the first, second and third holographic light source images may be first, second and third subpixels of a pixel. The controlling processes may involve forming the first, second and third holographic light source images at substantially the same time. Alternatively, or additionally, the controlling processes may involve forming the first, second and third holographic light source images in a time sequence. For example, the controlling processes may involve forming the first, second and third holographic light source images according to a field-sequential color method.

In some implementations, the software may include instructions for controlling the display device to reproduce a frame of image data by scanning a sequence of holographic light source images across the light-turning layer. In some implementations, the controlling processes may involve controlling a first programmable hologram of the programmable hologram system to form the first holographic light source image of the first color, controlling a second programmable hologram of the programmable hologram system to form the second holographic light source image of the second color and controlling a third programmable hologram of the programmable hologram system to form the third holographic light source image of the third color.

The software also may include instructions for controlling the display device to control the programmable hologram system and the light source system to form a fourth holographic light source image of a fourth color at a fourth location of the light-turning layer. The fourth holographic light source image may be a fourth subpixel of the pixel.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a system block diagram illustrating a display device that includes a programmable hologram system.

FIG. 2 is a top view of a programmable hologram forming a holographic image of a point light source in a light-turning layer.

FIG. 3 is a flow diagram illustrating a process of controlling a display device that includes a programmable hologram system.

FIG. 4A is a top view of four programmable holograms forming holographic images of point light sources in a single location of a light-turning layer.

FIG. 4B is a top view of four programmable holograms forming holographic images of point light sources in multiple nearby locations of a light-turning layer.

FIG. 5 is a flow diagram illustrating a process of controlling a display device such as that depicted in FIG. 4B.

FIG. 6A is a top view of a programmable hologram forming a holographic line light source image and a holographic area light source image within a light-turning layer.

FIG. 6B is a top view of two programmable holograms forming holographic images of point light sources in two different areas of a light-turning layer.

FIG. 7A is a cross-sectional illustration of a programmable hologram forming a holographic image of a point light source in a light-turning layer.

FIG. 7B is a perspective view of a programmable hologram forming a holographic image of a point light source in a light-turning layer.

FIGS. 8A and 8B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, a display device includes a light source system, a programmable hologram system, a light-turning layer and a control system. A control system may control the programmable hologram system to generate a sequence of holographic images of point light sources. For example, the control system may control the programmable hologram system according to software stored in a non-transitory medium. By scanning a sequence of holographic images of point light sources across the light-turning layer, a frame of image data can be formed.

The light source system may include one or more light sources, which may be disposed near one or more sides of the light-turning layer. The programmable hologram system may include one or more programmable holograms disposed between elements of the light source system and sides of the light-turning layer. In some such implementations, three programmable holograms may be paired with three light sources, e.g., of blue, green and red colors. Other implementations may include light sources of different colors, such as yellow, cyan or magenta. In some such implementations, four programmable holograms may be paired with four light sources, e.g., of blue, green, red and yellow colors.

In some such implementations, a control system may control the programmable hologram system to produce holographic images of point light sources in substantially the same location at substantially the same time. The intensities of the point light source images may be independently modulated to produce desired colors and grayscale at each point.

In alternative implementations, the control system may control the programmable hologram system to produce holographic images of point light sources in multiple locations at substantially the same time. For example, the control system may control the programmable hologram to generate a sequence of holographic images of line or area light sources by producing multiple holographic images of point light sources at substantially the same time. A frame of image data may be formed by scanning the sequence of holographic images of point, line, or area light sources across the light-turning layer. In alternative implementations, the control system may control different programmable holograms of the programmable hologram system to produce holographic images of point light sources in multiple areas of the light-turning layer at substantially the same time.

Particular implementations of the subject matter described in this disclosure can be implemented to realize one or more of the following potential advantages. Instead of a display having thousands or even millions of individually controllable pixels, such as an interferometric modulator (IMOD) or liquid crystal display (LCD) device, various implementations described herein allow for a relatively small number of controllable elements to produce an image over a relatively large display area. Instead, holographic images of point, line or area light sources are formed directly in a light-turning layer, where in some implementations, the light-turning layer is a passive light-turning layer. Accordingly, in some implementations no moving mechanical parts (such as the movable conductive plates of IMODs) are required in the display area, although some relatively small number of active (mechanical or liquid crystal or other) elements may be used in a programmable hologram associated with the display. Moreover, the display devices provided herein may provide more efficient use of light, because light produced by the holographic images formed in the light-turning layer may be viewed directly instead of being reflected from a reflective display or transmitted through a transmissive display. Some display devices provided herein may serve as a mirror, a window, etc., when the devices are switched off.

In some implementations, the light-turning features may be configured to direct light either towards or away from the edges of the light-turning layer. Accordingly, some devices described herein may simultaneously function as light-collection devices, e.g., as cameras configured for acquiring images from light incident on the light-turning layer. Some devices may be configured to function as both display devices and light-collection devices. For example, the same light-turning layer may be used as a display and to acquire image data of, e.g., a person viewing the display.

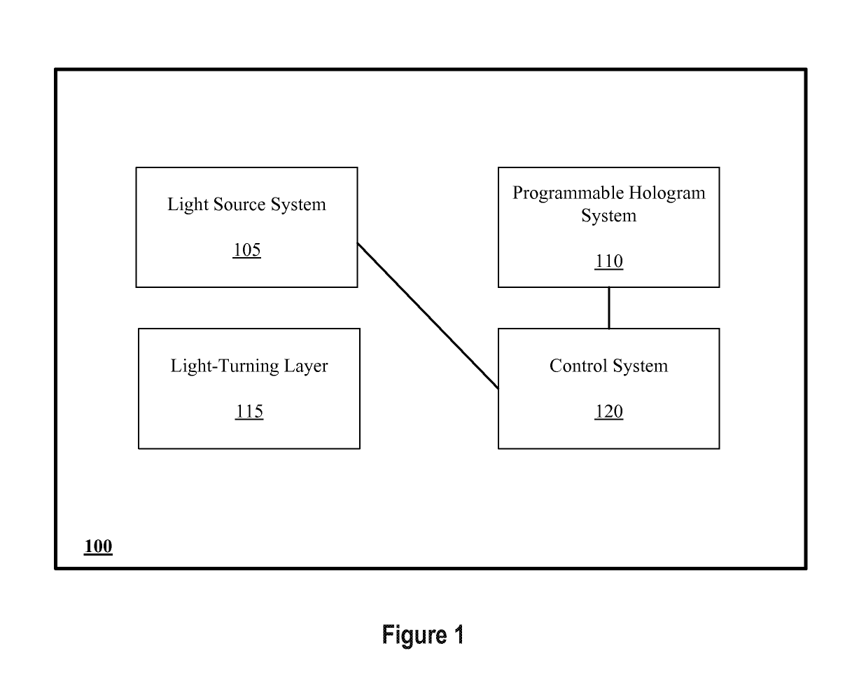

FIG. 1 is a system block diagram illustrating a display device that includes a programmable hologram system. In this example, the display device 100 includes a light source system 105, a programmable hologram system 110, a light-turning layer 115 and a control system 120.

The light source system 105 may include one or more light sources, which may be disposed near one or more sides of the light-turning layer 115. In some implementations, the light sources may be LEDs. However, performance of the display device 100 may be enhanced if the light from the light source system 105 is substantially collimated and/or coherent. Therefore, the light source system 105 may be configured to produce collimated light for illumination of the programmable hologram system. For example, the light source system 105 may include one or more laser diodes as light sources. Alternatively, or additionally, the light source system 105 may include collimating optics. Furthermore, in some of the various implementations described herein, the coherence length of the light produced by the light source system 105 can be at least equal to the distance from the light source system 105 to the furthest area or boundary of the light-turning layer 115 or the furthest extent of the intended displayable area in the light-turning layer 115.

In some implementations, a single element of the light source system 105 may include light sources for producing light of multiple colors. For example, a single element of the light source system 105 may include light sources for producing light of blue, green and red colors. Alternatively, or additionally, a light source system 105 (or an element thereof) may include light sources for producing light of other colors, such as white, yellow, cyan or magenta. In alternative implementations, a light source light source system 105 may include elements having one or more light sources for producing light of a single color, including, for example, blue, green, red, white, yellow, cyan or magenta colors.

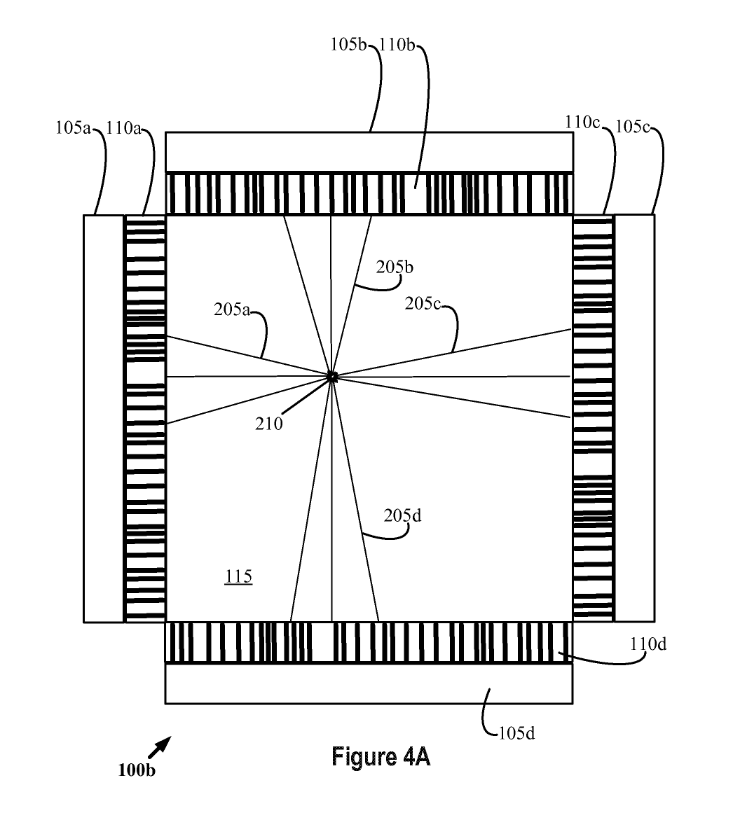

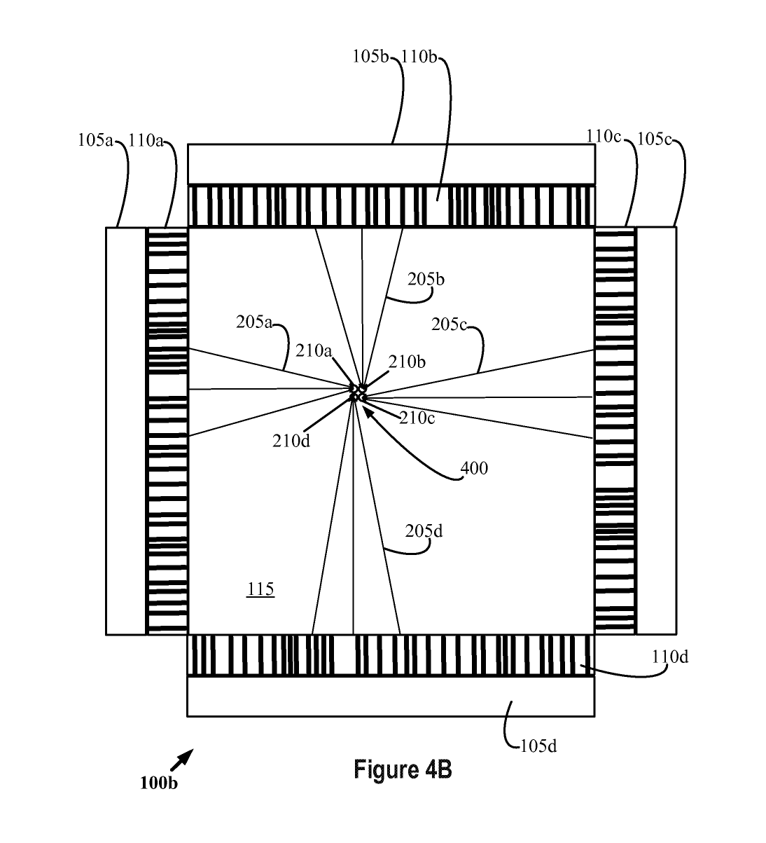

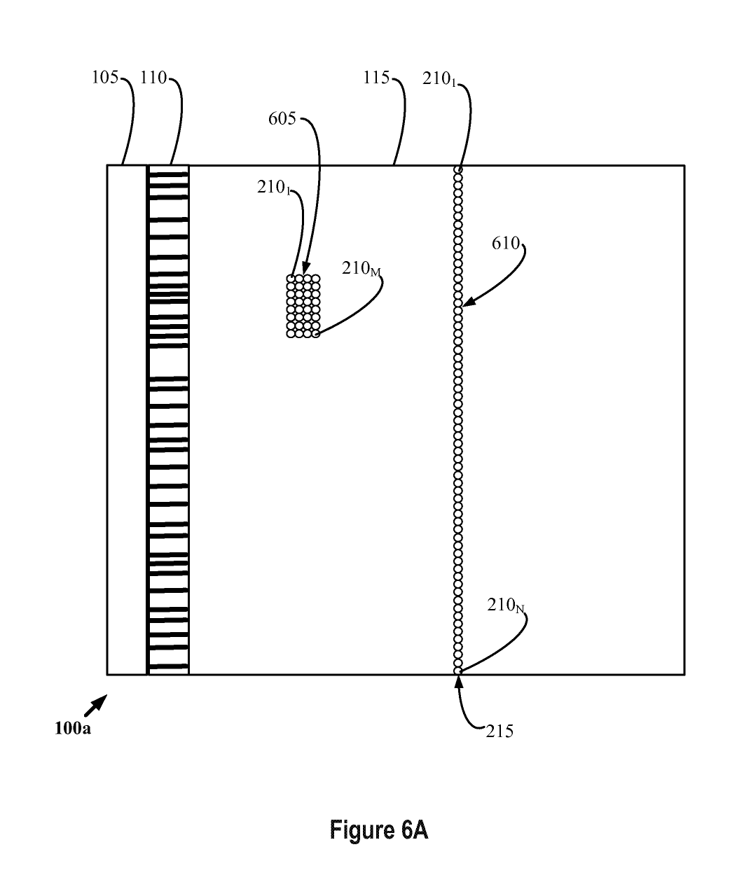

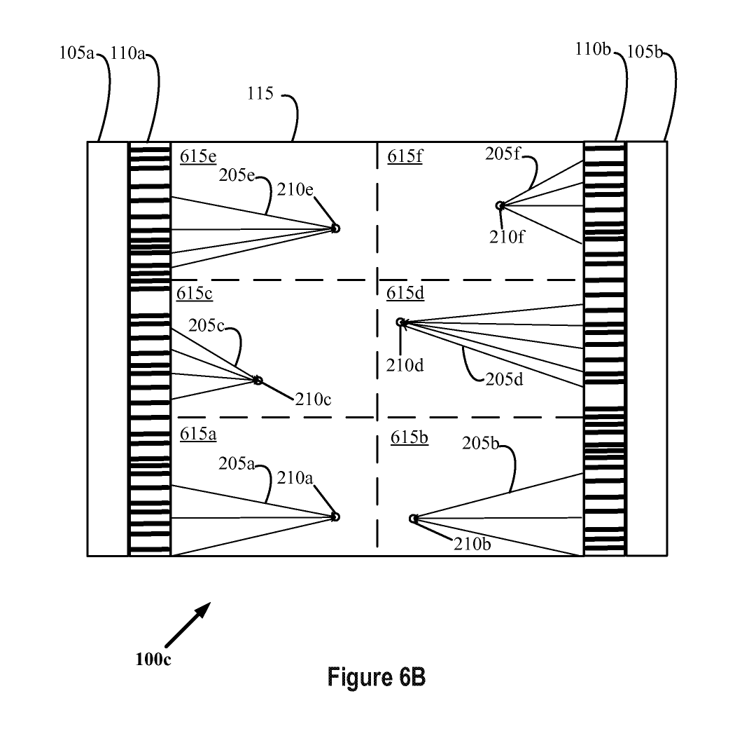

The programmable hologram system 110 may include one or more programmable holograms disposed between elements of the light source system 105 and sides of the light-turning layer 115. Some implementations include multiple programmable holograms, each programmable hologram being disposed on a different side of the light-turning layer 115, as illustrated in FIGS. 4A, 4B, and 6B. In some such implementations, each programmable hologram may be paired with an element of the light source system 105 that includes light sources configured for producing light of a single color.

For example, three programmable holograms may be paired with three elements of the light source system 105 or four programmable holograms may be paired with four elements of the light source system 105. Each element of the light source system 105 may include light sources configured for producing light of a single color, such as blue, green, red, yellow, cyan, magenta, white or another color.

In some implementations, the programmable hologram(s) of the programmable hologram system 110 may include one or more acousto-optic modulators (AOMs), LCDs, IMODs or other devices that may be programmed to form a hologram. Some implementations of the programmable hologram system 110 may include transparent-to-opaque IMODs that are substantially transparent in one state and substantially opaque in another state. Alternative implementations of the programmable hologram system 110 may include an AOM, for example, that uses the acousto-optic effect to diffract and/or shift the frequency of light using sound waves. The acousto-optic effect is a type of photoelasticity, wherein a change of a material's permittivity is caused by a mechanical strain. The acousto-optic effect may be caused by strains resulting from an acoustic wave that has been produced within a substantially transparent medium, thereby causing a variation of the medium's refractive index.

Some substantially transparent materials displaying the acousto-optic effect (AOM materials) include fused silica, lithium niobate, arsenic trisulfide, tellurium dioxide and tellurite glasses, lead silicate, Ge₅₅As₁₂S₃₃, mercury(I) chloride, lead(II) bromide, and other materials. In some AOMs, a variation of the medium's refractive index may be induced by a strain resulting from the piezoelectric effect. For example, the piezoelectric effect may be caused by applying a voltage difference across the substantially transparent medium or across an adjacent piezoelectric material. In some such implementations, a piezoelectric transducer may be attached to a substantially transparent AOM material. An oscillating electric signal (e.g., controlled by the control system 120) may drive the transducer to vibrate, thereby creating compressional waves in the AOM material. Alternatively, the programmable hologram system 110 can include an LCD or transparent to opaque interferometric modulator array that can programmably create a pattern of opaque and transparent regions thereby forming a diffraction grating or pattern through which light from the light source system 105 passes.

The control system 120 may, for example, include at least one of a general purpose single- or multi-chip processor, a digital signal processor (DSP), an application specific integrated circuit (ASIC), a field programmable gate array (FPGA) or other programmable logic device, discrete gate or transistor logic, discrete hardware components, or combinations thereof. The control system 120 may be configured to control the operations of the display device 100. For example, the control system 120 may be configured to control the light source system 105 and the programmable hologram system 110 according to software stored in a non-transitory medium.

In some implementations of an AOM-based programmable hologram system 110, the control system 120 may be configured to control the variation of a substantially transparent AOM material's refractive index caused by the acousto-optic effect to produce a programmable diffraction grating or hologram in an AOM. Light from the light source system 105 may pass through the substantially transparent AOM material, interact with the programmable hologram and form one or more holographic light source images within the light-turning layer 115. As described below, the holographic light source images may be holographic point light source images, holographic line light source images or holographic area light source images.

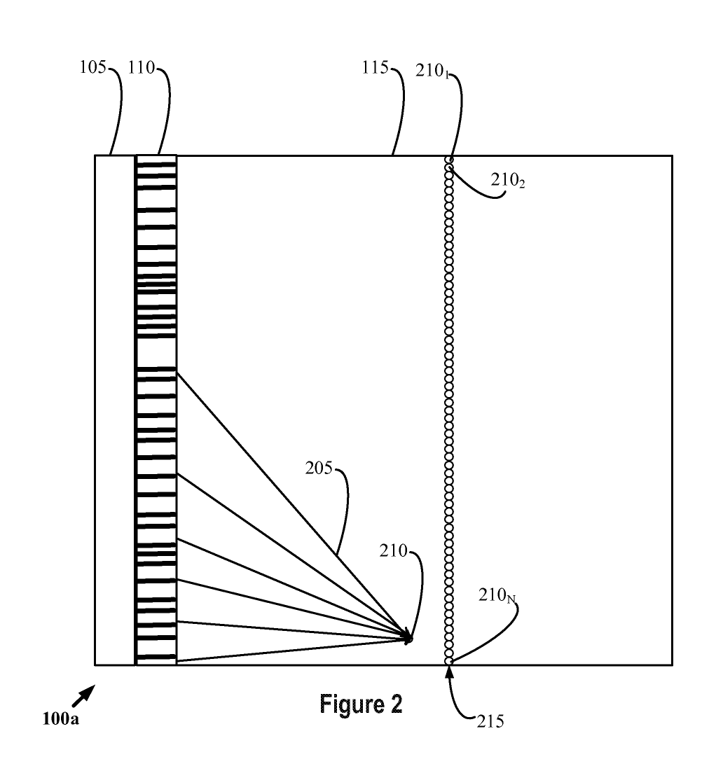

FIG. 2 is a top view of a programmable hologram forming a holographic image of a point light source in a light-turning layer. In this example, the display device 100a includes a light source system 105 disposed on a single side of the light-turning layer 115. In this example, the light source system 105 may include light sources for producing light of multiple colors. For example, the light source system 105 may include light sources for producing light of blue, green and red colors. Alternatively, or additionally, the light source system 105 may include light sources for producing light of other colors, such as white, yellow, cyan or magenta.

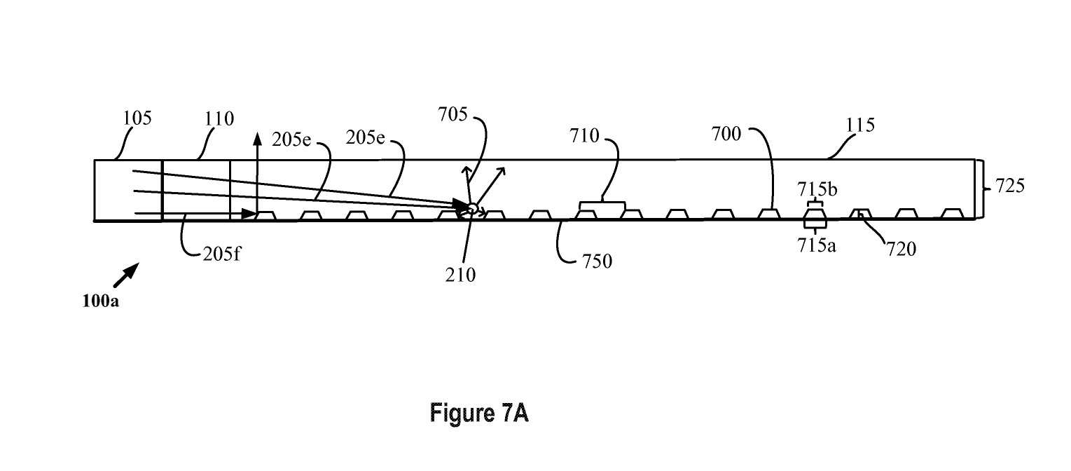

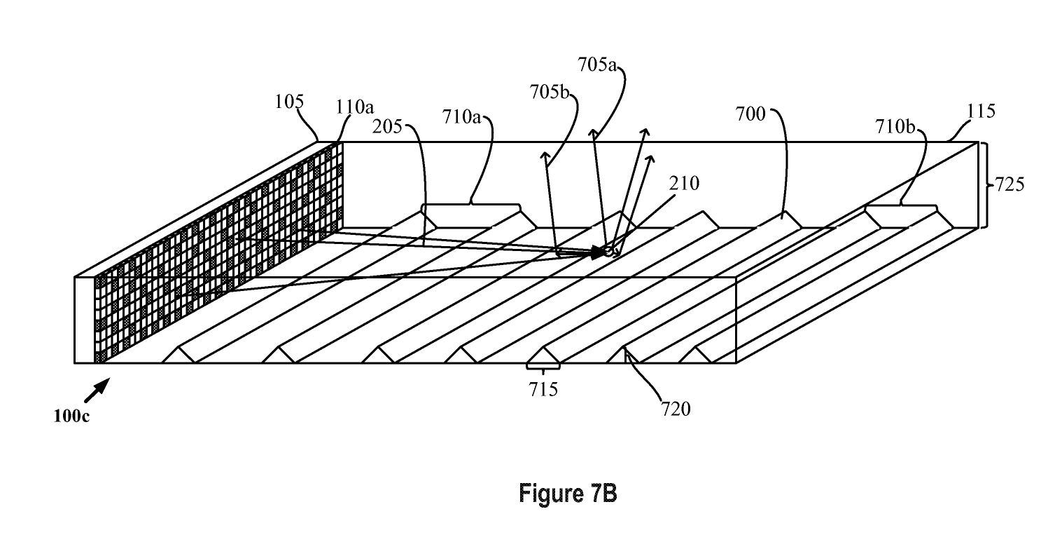

In this example, the programmable hologram system 110 includes a single programmable hologram disposed between the light source system 105 and the light-turning layer 115. Light from the light source system 105 may interact with the programmable hologram system 110 and form one or more holographic light source images within the light-turning layer 115. The black lines shown in the programmable hologram system 110 may represent, for example, fluctuations in the index of refraction across an AOM. Alternatively, the black lines may represent a pattern of transparent and opaque regions of an LCD or transparent-to-opaque IMOD array. The light-turning layer 155 may be configured to turn the light of the holographic images toward a viewer, as described further below with reference to FIGS. 7A and 7B.

In the example shown in FIG. 2, light rays 205 emerge from various portions of the programmable hologram system 110 and converge at a location 210 within the light-turning layer 115 to form a holographic image of a point light source. In some implementations, the area of the location 210 may be on the order of a millimeter squared. In other implementations, the area of the location 210 may be larger or smaller.

A control system (such as the control system 120 shown in FIG. 1) of the display device 100a may be configured to control the light source system 105 and the programmable hologram system 110 to generate a sequence of holographic images of such point light sources. By generating a sequence of holographic images of point light sources across the light-turning layer 115, for example by performing a raster scan, a frame of image data can be reproduced by the display device 100a. The intensities of the holographic point light source images may be independently modulated to produce desired colors and grayscale levels at each point.

For example, in some implementations the control system may be configured to control the light source system 105 and the programmable hologram system 110 to generate a sequence of holographic images of point light sources at locations 210₁ through 210_{N} within the light-turning layer 115, to form a column 215 of holographic images of point light sources. The column 215 may correspond to a column of virtual pixels or subpixels of the display 100a. The virtual pixels or subpixels are not physical components of the display device 100a, but instead correspond to holographic images. The column 215 may be one of a plurality of columns of pixels or subpixels that are sequentially formed on the display 100a. After all of the columns of pixels or subpixels have been formed, a frame of image data will have been reproduced on the display 100a.

As noted above, in some implementations the programmable hologram system 110 may include an AOM. The programmable diffraction grating or hologram in an AOM moves with a velocity equal to that of the speed of sound in the AOM material. Therefore, AOMs can change their configuration very rapidly, e.g., on the order of 10⁵ times per second. Such rapid changes in configuration can allow a large number of holographic images of point light sources to be scanned across the light-turning layer 115 within the time normally taken to write a frame of image data (currently on the order of 1/24 of second).

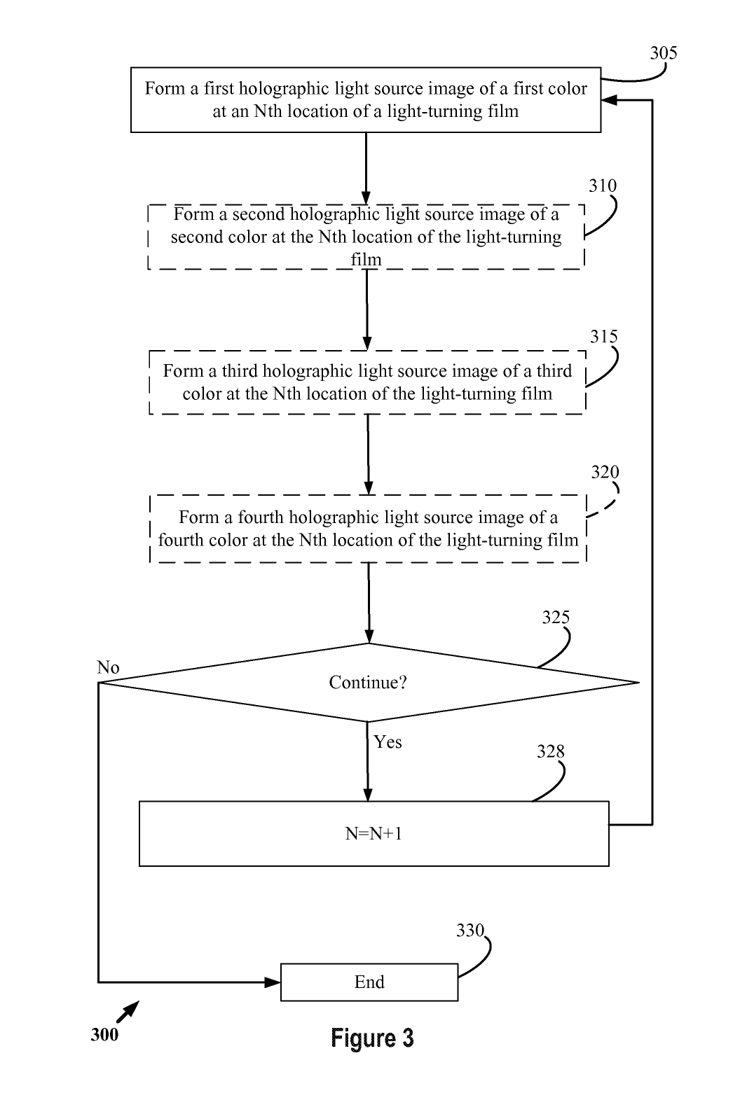

In some implementations, each of the locations 210 may correspond to a display pixel. Accordingly, multiple holographic images of point light sources may be formed at each of the locations 210₁ through 210_{N}, each of the images having a different color. One such example will now be described with reference to FIG. 3.

FIG. 3 is a flow diagram illustrating a process of controlling a display device that includes a programmable hologram system. As with other processes shown and described herein, the processes of the method 300 are not necessarily performed in the order shown in FIG. 3. In this example, the method 300 involves controlling a light source system (such as the light source system 105 of FIG. 2) and a programmable hologram system (such as the programmable hologram system 110 of FIG. 2) to form virtual pixels of a display. The method 300 begins with block 305, in which a first holographic light source image of a first color is formed at an N^{th} location of a light-turning layer. In some implementations, a programmable hologram system and a light source system may be controlled to form a first holographic light source image of a first color at a first location of a light-turning layer. For example, in block 305 a control system may control the light source system 105 and the programmable hologram system 110 of FIG. 2 to form a first holographic point light source image of a first color (e.g., red, blue, green, yellow, cyan or magenta) at a first location (e.g., at the location 210₁) within the light-turning layer 115.

In optional block 310, a first holographic light source image of a second color is formed at an N^{th} location of the light-turning layer. In some implementations, a programmable hologram system and a light source system may be controlled to form a second holographic light source image of a second color at the first location of the light-turning layer. The second color may be different from the first color. In some implementations, the same instances of the programmable hologram system and the light source system may be used to form the first and second holographic point light source images. For example, referring again to FIG. 2, in block 310 a control system may control the light source system 105 and the programmable hologram system 110 to form a second holographic point light source image of a second color at the first location (e.g., at the location 210₁) within the light-turning layer 115 by illuminating the programmable hologram system 110 with a second color that is different from the first color. Because the wavelength of light is changing, the pattern of the programmable hologram system 110 may need to change according to the wavelength of the light, in order to form the first holographic point light source image of the second color at the first location using the same instances of the programmable hologram system and the light source system that were used to form the first holographic point light source image of the first color in block 305. However, as described below with reference to FIG. 4A, in some implementations different instances of the programmable hologram system and the light source system may be used to form the first and second holographic point light source images.

In optional block 315, a first holographic light source image of a third color is formed at an N^{th} location of the light-turning layer. In some implementations, a programmable hologram system and a light source system may be controlled to form a third holographic light source image of a third color at the first location of the light-turning layer. The third color may be different from the first color and the second color.

In some implementations, method 300 may involve forming additional holographic point light source images of additional colors at the first location. For example, in optional block 320, a first holographic light source image of a fourth color is formed at an N^{th} location of the light-turning layer. In some implementations, a programmable hologram system and a light source system may be controlled to form a fourth holographic light source image of a fourth color at the first location of the light-turning layer. The fourth color may be different from the first, second and third colors. Some implementations may involve forming five or more holographic point light source images of five or more colors at the first location.

The method 300 may involve independently modulating the intensities of the point light source images to produce desired colors and/or grayscale levels at each location. In some implementations, the colors and/or grayscale levels at each location may be modulated according to a field-sequential color method. For example, if the desired color at a location is orange, a red light source, a yellow light source and one or more programmable holograms may be controlled to form red and yellow holographic point light source images of a desired intensity at the first location.

In this example, after all of the holographic point light source images of all colors have been formed at the first location, a first pixel of image data has been written to a display device. In block 325, it may be determined whether the method 300 will continue. If the control system receives an indication (such as input from a user input system) that the method 300 should end, the method 300 proceeds to block 330 and terminates in this example.

Otherwise, the method 300 proceeds to block 328, wherein a new location may be selected to form one or more holographic images. In this example, N is incremented to N+1 in block 328, so that the one or more holographic images are formed in a different location from the original N^{th} location. The method 300 may revert to block 305, wherein a first holographic light source image of a first color may be formed at the new Nth location of the light-turning film. For example, the control system may be configured to control the light source system and the programmable hologram system to form another holographic point light source image of the first color at a second location within the light-turning layer. The second location may or may not be adjacent to the first location, according to the particular implementation. Referring to FIG. 2, for example, if the first location is the location 210₁, the second location may be the location 210₂. Then, a second holographic point light source image of a second color, a third holographic point light source image of a third color, etc., may be formed at the second location in blocks 310 et seq. In this example, after all of the holographic point light source images of all colors have been formed at the second location, a second pixel of image data will have been written to the display device.

The process may continue until all pixels of a frame of image data have been reproduced on the display device. Additional frames of image data may be reproduced on the display device in a similar fashion.

In alternative implementations, different instances of the programmable hologram system and the light source system may be used to form holographic point light source images of different colors at substantially the same location. One such implementation will now be described with reference to FIG. 4A.

FIG. 4A is a top view of four programmable holograms forming holographic images of point light sources in a single location of a light-turning layer. In this example, a light source system of the display device 100b includes light source elements 105a, 105b, 105c and 105d. A programmable hologram system of the display device 100b includes programmable holograms 110a, 110b, 110c and 110d. A control system of the display device 100b (not shown) may be configured to form holographic point light source images of different colors at substantially the same location. In some such implementations, programmable holograms 110a, 110b, 110c and 110d may be paired with light source elements 105a, 105b, 105c and 105d that are configured for producing light of blue, green, red and yellow colors, respectively. Other implementations may include light source elements having light sources for providing different colors, such as white, yellow, cyan or magenta.

In some implementations, as shown in FIG. 4A, holographic point light source images of different colors may be formed at substantially the same location and during substantially the same time interval within the light-turning layer. In the example shown in FIG. 4A, the control system is controlling the light source element 105a to illuminate the programmable hologram 110a with a first color of light. This light has interacted with the programmable hologram 110a to produce the light rays 205a, which converge to form a first holographic image of a point light source of the first color at the location 210 in the light-turning layer.

In this example, at substantially the same time, the control system is controlling the light source element 105b to illuminate the programmable hologram 110b with a second color of light to produce the light rays 205b, which converge to form a second holographic image of a point light source of the second color at the location 210. At substantially the same time, the light source element 105c and the programmable hologram 110c produce the light rays 205c, which converge to form a third holographic image of a point light source of a third color at the location 210. Similarly, the light source element 105d and the programmable hologram 110d produce the light rays 205d, which converge to form a fourth holographic image of a point light source of a fourth color at the location 210.

As shown in FIG. 4A, some implementations allow 3, 4 or more holographic images of a point light sources, each of the images being formed using a different color, to be formed in substantially the same location of a display at substantially the same time. The intensities of the point light source images may be independently modulated to produce desired colors and grayscale levels at each location. In this manner, different color components of a pixel of image data may be written at substantially the same time. This may be advantageous for various reasons.

For example, in some implementations, such as a video implementation, may call for a relatively large number of holographic images of point light sources to be formed within the time allotted for one frame of image data to be written. If we assume, by way of example, that the area of each location 210 is approximately one millimeter squared, a display having an active area of 6 cm by 10 cm would require holographic images of point light sources to be formed in approximately 6000 of the locations 210 during the time that a frame of image data is written to the display. (An actual display may have a greater or smaller active area.) If we also assume that 24 frames of image data are written each second, this means that 24 holographic images of point light sources of each color would formed in each of the locations 210 during each second, for a total of approximately 144,000 holographic images of point light sources of each color, per second. If holographic images of point light sources of each color are being provided simultaneously by a plurality of light source element and programmable holograms, this would mean that the configuration of the programmable holograms would change approximately 144,000 times per second and that the corresponding light source elements would flash approximately 144,000 times per second. If the display includes fewer programmable holograms and/or light source elements, still more rapid flashing and/or programmable hologram configuration changes may be required.

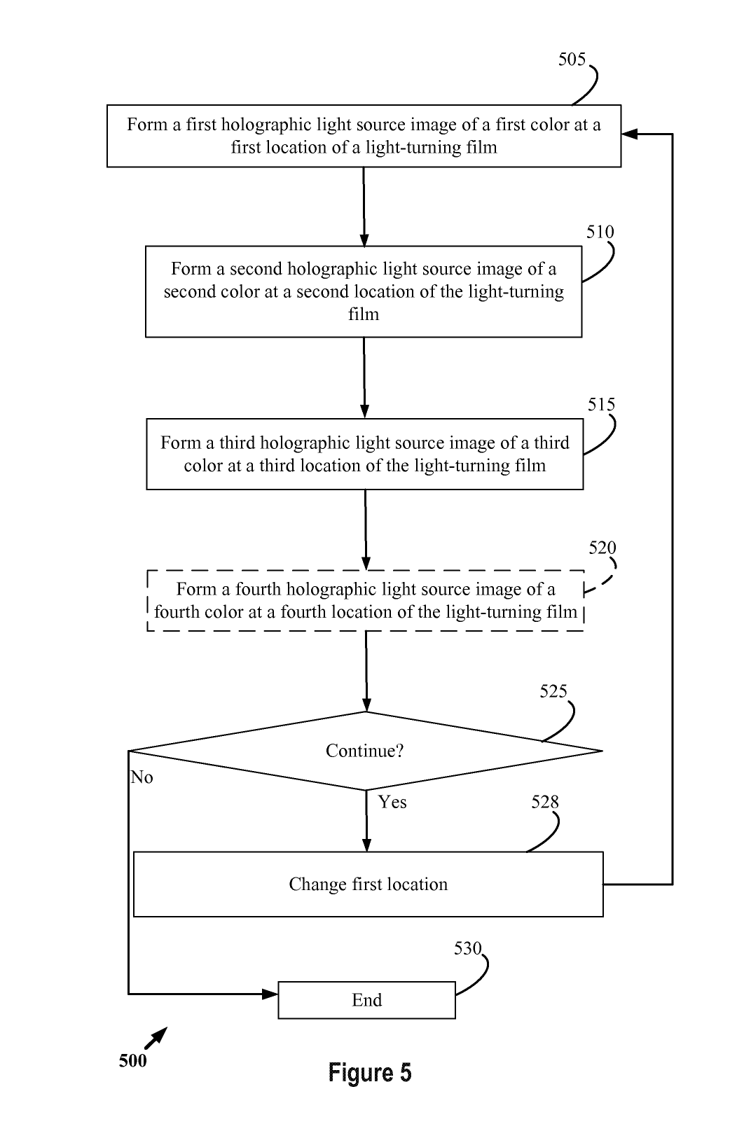

In alternative implementations, each of the locations 210 may correspond to a subpixel of image data. Accordingly, holographic images of point light sources may be formed at each of the locations 210₁ through 210_{N}, each of the images having a different color and corresponding to a subpixel. Groups of 3, 4 or more images of different colors may be formed in nearby locations 210, collectively forming a pixel of image data. Some such implementations will now be described with reference to FIGS. 4B and 5.

FIG. 4B is a top view of four programmable holograms forming holographic images of point light sources in multiple nearby locations of a light-turning layer. FIG. 5 is a flow diagram illustrating a process of controlling a display device such as that depicted in FIG. 4B. Method 500 of FIG. 5 begins by forming a first holographic light source image of a first color at a first location of a light-turning film. In some implementations, block 505 may involve controlling a programmable hologram system and a light source system to form a first holographic light source image of a first color at a first location of a light-turning layer. For example, a control system (not shown) may control the light source element 105a of FIG. 4B to illuminate the programmable hologram 110a with a first color of light to produce the light rays 205a, which form a first holographic image of a point light source of the first color at the location 210a.

Block 510 of FIG. 5 involves forming a second holographic light source image of a second color at a second location of a light-turning film. The second location may be proximate the first location. For example, block 510 may involve controlling a programmable hologram system and a light source system to form a second holographic light source image of a second color at a second location of the light-turning layer. In some implementations, the programmable hologram system and the light source system may be the same programmable hologram system and light source system that performed the operations of block 505. However, in the example shown in FIG. 4B, the control system is controlling the light source element 105b to illuminate the programmable hologram 110b with a second color of light to produce the light rays 205b, which form a second holographic image of a point light source of the second color at the location 210b. Moreover, the pattern formed in the programmable hologram system may need to change, due to changing the wavelength of light from that of the first color to that of the second color and/or the difference in the location between the first location and the second location.

Block 515 of FIG. 5 involves forming a third holographic light source image of a third color at a third location of a light-turning film. The third location may be proximate the first and second locations. For example, block 515 may involve controlling a programmable hologram system and a light source system to form a third holographic light source image of a third color at a third location of the light-turning layer. In the example shown in FIG. 4B, the light source element 105c and the programmable hologram 110c produce the light rays 205c, which form a third holographic image of a point light source of a third color at the location 210c.

In optional block 520, a fourth holographic light source image of a fourth color is formed at a fourth location of a light-turning film. The fourth location may be proximate the first, second and third locations. For example, block 520 may involve controlling a programmable hologram system and a light source system to form a fourth holographic light source image of a fourth color at a fourth location of the light-turning layer. As shown in FIG. 4B, the light source element 105d and the programmable hologram 110d may produce the light rays 205d, which form a fourth holographic image of a point light source of a fourth color at the location 210d.

The locations 210a, 210b, 210c and 210d are adjacent locations in this example. Moreover, in this example each of the holographic images of point light sources has a different color and corresponds to a different subpixel. Collectively, the holographic images at the locations 210a, 210b, 210c and 210d form a pixel 400 of image data. In this example, the holographic images are formed at the locations 210a, 210b, 210c and 210d at substantially the same time. In other words, the processes of blocks 505-520 of FIG. 5 may be performed at substantially the same time. In some implementations, the processes of blocks 505-520 of FIG. 5 may be performed during time intervals that overlap or coincide, at least in part.

However, in alternative implementations, the light source elements 105a-105d and the programmable holograms 110a-110d may form holographic images of point light sources of first through fourth colors at locations 210a-210d in a sequence, instead of substantially at the same time. In some alternative implementations, the pixel 400 may include more or fewer subpixels.

In block 525 of FIG. 5, it may be determined whether the method 500 will continue. If so, the process may continue to block 528, wherein a new first location is selected. The new first location may or may not be substantially adjacent to the original first location. The method 500 may then revert to the block 505, wherein a first holographic light source image of the first color may be formed at the new first location of the light-turning film. In block 510, a second holographic light source image of the second color may be formed at a new second location of the light-turning film, and so on. The new first, second, third (and optionally fourth) locations may be proximate one another. In this manner, another pixel of image data may be reproduced on the display. The display device may be configured to form a plurality of pixels in sequence, in order to reproduce a frame of image data. The method 500 may be continued in order to write multiple frames of image data in the same fashion.

In yet other alternative implementations, a control system may control a programmable hologram system and a light source system to generate a sequence of holographic images of line or area light sources. A frame of image data may be formed by scanning the sequence of holographic images of line or area light sources across the light-turning layer.

FIG. 6A is a top view of a programmable hologram forming a holographic line light source image and a holographic area light source image within a light-turning layer. In some implementations of this example, the programmable hologram system 110 is configured to form a holographic line light source image or a holographic area light source image by superimposing the holograms for producing each of a plurality of holographic point light source images. For example, in order to produce the holographic area light source image 605, the programmable hologram system 110 superimposes the patterns required to produce holographic point light source images at each of the locations 210₁ through 210_{M}. When illuminated by light from the light source system 105, the programmable hologram system 110 may form holographic point light source images at each of the locations 210₁ through 210_{M} at substantially the same time, forming the holographic area light source image 605. A frame of image data may be formed on the display device 100a by generating a sequence of the holographic area light source images 605.

Similarly, in order to produce the holographic line light source image 610, the programmable hologram system 110 superimposes the patterns required to produce holographic point light source images at each of the locations 210₁ through 210_{N}. When illuminated by light from the light source system 105, holographic point light source images are formed at each of the locations 210₁ through 210_{N} at substantially the same time, forming the holographic line light source image 610. A frame of image data may be formed on the display device 100a by generating a sequence of the holographic line light source images 610.

FIG. 6B is a top view of two programmable holograms forming holographic images of point light sources in different areas of a light-turning layer. In this example, the light source system includes the light source elements 105a and 105b, which are disposed on opposing sides of the light-turning layer 115. The programmable hologram system includes the corresponding programmable holograms 110a and 110b, each of which is configured to form holographic point light source images in different areas of the light-turning layer 115. Here, the light source element 105a and the programmable hologram 110a may be configured to form holographic point light source images in locations 210a, 210c and 210e of areas 615a, 615c and 615e, respectively. The light source element 105b and the programmable hologram 110b may be configured to form holographic point light source images in locations 210b, 210d and 210f of areas 615b, 615d and 615f, respectively, at substantially the same time that the light source element 105a and the programmable hologram 110a are forming holographic point light source images in the areas 615a, 615c and 615e. A frame of image data may be formed on the display device 100c that includes a plurality of holographic point light source images formed in each of the areas 615a-615f. In some such implementations, holographic point light source images formed in substantially all parts of the areas 615a-615f during the time that the frame of image data is formed.

In alternative implementations, the display device 100c may include more or fewer light source elements and programmable holograms. For example, the light source elements and programmable holograms may be disposed on one side, three sides or four sides of the light-turning layer 115. In some implementations, there may be a separate light source element/programmable hologram pair for each of the areas 615. The light source elements and programmable holograms may be configured to generate a sequence of holographic light source images in more or fewer areas 615. Moreover, the light source elements and programmable holograms may be configured to generate a sequence of holographic line light source images and/or holographic area light source images in the areas 615.

Various configurations of programmable hologram systems 110, light-turning layers 115 and other elements may be used to implement the above-described methods and devices. Some examples will now be described with reference to FIGS. 7A and 7B. In the examples described with reference to FIGS. 7A and 7B, the light-turning layers 115 are “passive,” in the sense that the light-turning layers 115 have no controllable elements such as MEMs devices, etc. In these implementations, the location of a holographic light source image is the result of controlling the programmable hologram systems 110 and the light source systems 105, not of controlling the light-turning layers 115.

FIG. 7A is a cross-sectional illustration of a programmable hologram forming a holographic image of a point light source in a light-turning layer. In this example, the display device 100a includes a light-turning layer 115, which may be a film, a plate, etc. The light-turning layer 115 may be substantially similar to currently available light-turning layers, such as light-turning films used in the front lights of reflective displays. Accordingly, the light-turning layer 115 may be formed of a substantially transparent light guide material configured to direct light within a plane of the light-turning layer 115, e.g., via internal reflection. The light-turning layer 115 also may include a plurality of reflective light-turning elements 700 for extracting light from the light guide layer. When illuminated by light from the light source system 105, the programmable hologram system 110 may form a holographic point light source image at the location 210. Light rays 705 from the holographic point light source image may emerge directly from the location 210 or may be reflected from the light-turning elements 700.

The light-turning elements 700 may have various configurations, depending on the particular implementation. For example, the light-turning elements 700 may be facets, dots, holographic light-turning features, etc. The light-turning elements 700 may or may not be continuous in the plane perpendicular to FIG. 7A. For example, in some implementations the light-turning elements 700 may be isolated frusta (truncated cones or pyramids), whereas in other implementations the light-turning elements 700 may be prisms having axes that extend out of the plane of FIG. 7A, across part or all of the light-turning layer 115. In this example, the light-turning elements 700 have a substantially uniform pitch 710, whereas in other implementations (e.g., as shown in FIG. 7B) the pitch 710 may vary. Although the size of the location 210 appears to be smaller than the pitch 710 of the light-turning elements 700 in FIG. 7A, it may be preferable that the pitch 710 is smaller than the diameter of the holographic point light source image at the location 210. In some implementations, the pitch 710 may be in the range of 1 to 100 microns. In some such implementations, the pitch 710 may be in the range of 50 to 100 microns, e.g., approximately 75 microns.

Here, the light-turning elements 700 are formed as polygons having a base width 715a and a narrower top width 715b. In some implementations, the base width 715a may be in the range of 1 to 50 microns, for example, approximately 25 microns, and the top width 715b may be in the range of 1 to 25 microns, for example, approximately 12 microns. The light-turning elements 700 may have a height 720 in the range of 1-20 microns, for example, approximately 10 microns. However, in other implementations the light-turning elements 700 may have different shapes and/or sizes.

The resolution of the display devices 100 generally corresponds to the size of the holographic point light source images: the smaller the images, the higher the resolution. In various implementations, at least two factors may affect the size of the holographic light source images and therefore the resolution of the display devices 100. One factor is the resolution of the programmable hologram system 110, for example, the size of the compression waves for an AOM or the resolution of an LCD array. The other factor is the size of the light turning feature. Relatively larger light turning features in the light-turning layer (and/or lower resolution programmable holograms) may result in larger virtual pixels and lower resolution, whereas relatively smaller light turning features (and/or higher resolution programmable holograms) in the light-turning layer may result in smaller virtual pixels and higher resolution.

In this implementation, the light-turning layer 115 may have a thickness 725 in the range of 50 to 500 microns, for example, approximately 300 microns. Although such light-turning layers 115 may provide satisfactory performance, they have potential disadvantages. In the example shown in FIG. 7A, the light rays 205e form the holographic point light source image at the location 210. However, some of the light rays 205f may be deflected by a light-turning element 700 before reaching the location 210. This may cause the light from the holographic point light source image at the location 210 to have a lower intensity. Moreover, the deflected light may illuminate the wrong part of the display, appearing as undesirable artifacts to a viewer and/or causing lower display contrast.

Some implementations of the display device 100 may include a dark background (for example, a black background) disposed behind the light-turning layer, from the perspective of an observer. One such example is the dark background 750 of FIG. 7A. The dark background 750 can provide contrast with the holographic light source images formed in the light-turning layer 115. In some implementations, the dark background 750 may include a dark pigment, such as dark ink or dark paint. In other implementations, the dark background 750 may be formed of an interferometric black mask that does not reflect a substantial amount of incident visible light.

Some implementations provided herein can substantially alleviate such problems. FIG. 7B is a perspective view of a programmable hologram forming a holographic image of a point light source in a light-turning layer. In the example shown in FIG. 7B, the display device 100c includes light-turning elements 700 that are triangular in cross-section, although light-turning elements 700 similar to those described above may also be used. In this implementation, the pitch 710 of the light-turning elements 700 varies according to their distance from the light source system 105: the pitch 710a closer to the light source system 105 is greater than the pitch 710b farther away from light source system 105. Accordingly, the light extraction efficiency of the light-turning elements 700 increases with increasing distance from the light source system 105, although the example of FIG. 7B may be implemented with light-turning elements 700 having a uniform pitch. The height 720 and width 715 of the light-turning elements 700 shown in FIG. 7B may be comparable to those shown in FIG. 7A.

However, the display device 100c includes a light source system 105, a programmable hologram system 110 and a light-turning layer 115 that are substantially thicker than those of the implementation shown in FIG. 7A. For example, the thickness 725 may be in the range of 1 mm to 10 mm, e.g., approximately 5 mm. The increased thickness, combined with a similar height 720 of the light-turning elements 700, allows for a larger number of the light rays 205 to reach the locations 210 within the light-turning layer.

The configuration shown in FIG. 7B may provide other potential advantages. Due to the increased thickness of the programmable hologram system 110, the programmable hologram system 110 may be configured as a two-dimensional programmable hologram thereby allowing better control of the location of the holographically formed point source image in three dimensions. This allows the hologram to be formed in three dimensions right at the surface of the light-turning layer where the light-turning is formed. This reduces the likelihood that light rays will totally internally reflect and hit light-turning elements 700 before reaching the intended holographically formed point, line, or area light source image which would result in loss of brightness of the holographic image. Alternatively, the two-dimensional programmable hologram could be configured as separate programmable holograms, for example, at each row of the array shown in FIG. 7B. Each of these programmable holograms could be configured to produce a separate holographic image of a point light source in the light-turning layer 115. Accordingly, the display device 100c may be configured to produce a holographic line light source image or a holographic area light source image, such as the holographic area light source image 605 and the holographic line light source image 610 shown in FIG. 6A, without the need for superimposing the holograms for producing the individual holographic point light source images.

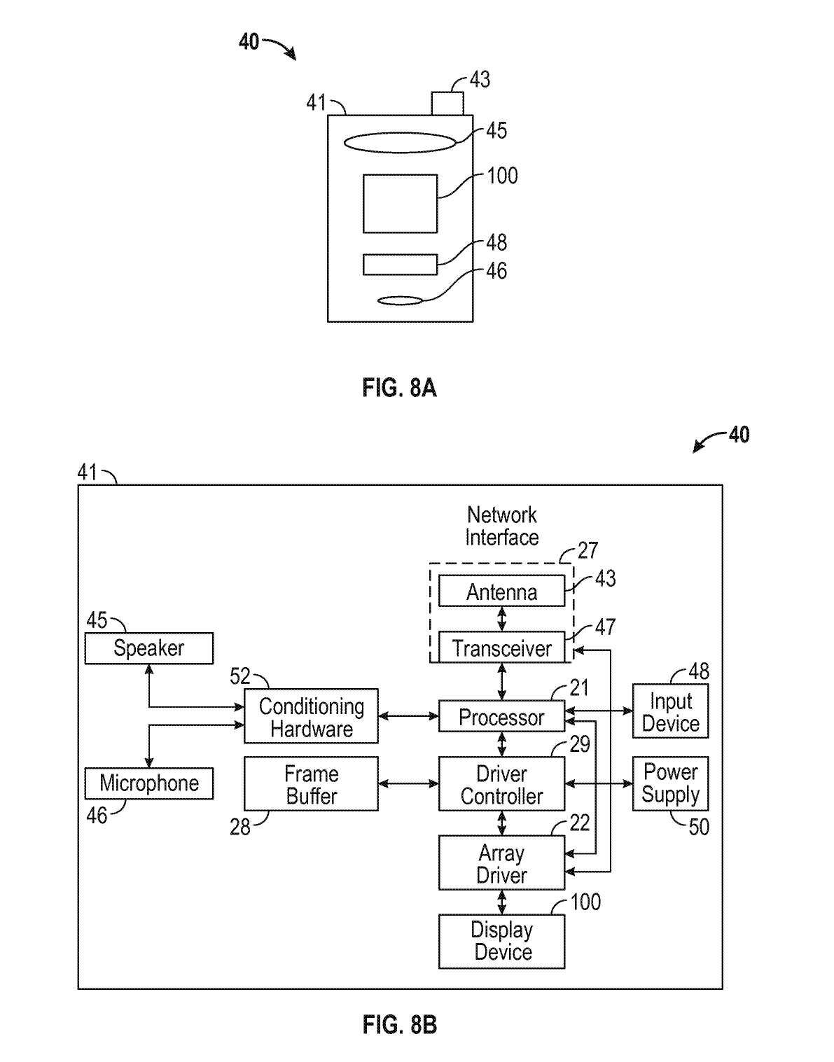

FIGS. 8A and 8B are system block diagrams illustrating a device 40. The device 40 can be, for example, a smart phone, a cellular or mobile telephone. However, the same components of the device 40 or slight variations thereof are also illustrative of various types of display devices such as televisions, computers, tablets, e-readers, hand-held devices and portable media devices.

The device 40 includes a housing 41, a display device 100, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display device 100 may be substantially similar to any of the programmable hologram-based display devices described herein. Accordingly, the display device 100 may include a light source system, a programmable hologram system and a light-turning layer, although these elements are not shown in FIG. 8A or 8B.

The components of the device 40 are schematically illustrated in FIG. 8A. The device 40 includes a housing 41 and can include additional components at least partially enclosed therein. For example, the device 40 includes a network interface 27 that includes an antenna 43 which can be coupled to a transceiver 47. The network interface 27 may be a source for image data that could be displayed on the device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display device 100. One or more elements in the device 40, including elements not specifically depicted in FIG. 8A, can be configured to function as a memory device and be configured to communicate with the processor 21. In some implementations, a power supply 50 can provide power to substantially all components in the particular device 40 design.

The network interface 27 includes the antenna 43 and the transceiver 47 so that the device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the device 40. The conditioning hardware 52 may include amplifiers and filters for transmitting signals to the speaker 45, and for receiving signals from the microphone 46. The conditioning hardware 52 may be discrete components within the device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display device 100. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the processor 21, the driver controller 29 and/or the array driver 22 may be configured for controlling the types of display devices described herein. For example, the processor 21, the driver controller 29, and/or the array driver 22 may be configured to control a light source system and a programmable hologram system to form holographic light source images within a light-turning layer.

In some implementations, the input device 48 can be configured to allow, for example, a user to control the operation of the device 40. The input device 48 can include a keypad, such as a QWERTY keyboard or a telephone keypad, a button, a switch, a rocker, a touch-sensitive screen, a touch-sensitive screen integrated with the display device 100, or a pressure- or heat-sensitive membrane. The microphone 46 can be configured as an input device for the device 40. In some implementations, voice commands through the microphone 46 can be used for controlling operations of the device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a non-transitory computer-readable medium. The steps of a method or algorithm disclosed herein may be implemented in a processor-executable software module which may reside on a non-transitory computer-readable medium. Computer-readable media include both computer storage media and communication media including any medium that can be enabled to transfer a computer program from one place to another. Storage media may be any available media that may be accessed by a computer. By way of example, and not limitation, non-transitory computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, terms such as “upper,” “lower,” “row,” “column,” etc., are sometimes used for ease of describing the figures, and indicate relative positions corresponding to the orientation of the figure on a properly oriented page, and may not reflect the proper orientation of, e.g., a display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A display device, comprising:
a light source system including a first light source configured for producing light of a first color;
a light-turning layer;
a programmable hologram system including a first programmable hologram disposed proximate the light source system and the light-turning layer so as to be capable of forming a first holographic light source image of the first color in the light-turning layer; and
a control system configured to control the programmable hologram system and the light source system to form the first holographic light source image of the first color within the light-turning layer.

2. The display device of claim 1, wherein the control system is configured to control the programmable hologram system and the light source system to generate a sequence of holographic point light source images.

3. The display device of claim 1, wherein the control system is configured to control the programmable hologram system and the light source system to generate a sequence of holographic line light source images.

4. The display device of claim 1, wherein the control system is configured to control the programmable hologram system and the light source system to generate a sequence of holographic area light source images within the light-turning layer.

5. The display device of claim 1, wherein the light source system further comprises:
a second light source configured for producing light of a second color; and
a third light source configured for producing light of a third color.

6. The display device of claim 5, wherein the control system is further configured to:
control the first programmable hologram to form a second holographic light source image of the second color within the light-turning layer; and
control the first programmable hologram to form third holographic light source image of the third color within the light-turning layer.

7. The display device of claim 5, wherein the programmable hologram system further comprises:
a second programmable hologram proximate the second light source and the light-turning layer; and
a third programmable hologram proximate the third light source and the light-turning layer, wherein the control system is further configured to:
control the second programmable hologram and the second light source to form a second holographic light source image of the second color within the light-turning layer; and
control the third programmable hologram and the third light source to form a third holographic light source image of the third color within the light-turning layer.

8. The display device of claim 7, wherein the control system is further configured to form the first, second and third holographic light source images in substantially the same area of the light-turning layer at substantially the same time.

9. The display device of claim 5, wherein the control system is further configured to form a frame of image data by scanning a sequence of holographic light source images across the light-turning layer.

10. The display device of claim 5, wherein the control system is further configured to control the first, second and third light sources and the programmable hologram system according to a field-sequential color method.

11. The display device of claim 5, wherein the light source system further comprises:
a fourth light source configured for producing light of a fourth color.

12. The display device of claim 11, wherein the control system is further configured to control the first programmable hologram to form fourth holographic light source images of the fourth color within the light-turning layer.

13. The display device of claim 11, wherein the programmable hologram system further comprises:
a second programmable hologram proximate the second light source and the light-turning layer;
a third programmable hologram proximate the third light source and the light-turning layer; and
a fourth programmable hologram proximate the fourth light source and the light-turning layer, wherein the control system is further configured to:
control the second programmable hologram and the second light source to form a second holographic light source image of the second color within the light-turning layer;
control the third programmable hologram and the third light source to form a third holographic light source image of the third color within the light-turning layer; and
control the fourth programmable hologram and the fourth light source to form fourth holographic light source images of the fourth color within the light-turning layer.

14. The display device of claim 1, wherein the light-turning layer includes a plurality of light-turning elements.

15. The display device of claim 14, wherein the light-turning elements include facets, frusta, light-scattering dots, or diffractive elements.

16. The display device of claim 14, wherein a light extraction efficiency of the light-turning elements increases with increasing distance from the first light source.

17. The display device of claim 1, further comprising:
a memory device that is configured to communicate with the control system, wherein the control system includes a processor that is configured to process image data.

18. The display device of claim 17, further comprising:
an image source module configured to send the image data to the processor, wherein the image source module includes at least one of a receiver, a transceiver or a transmitter.

19. The display device of claim 17, further comprising:
an input device configured to receive input data and to communicate the input data to the processor.

20. A display device, comprising:
a light source system including a first light source for producing light of a first color;
a light-turning layer;
programmable hologram means for forming a first holographic light source image of the first color; and
a control system configured for controlling the programmable hologram means and the light source system to form the first holographic light source image of the first color within the light-turning layer.

21. The display device of claim 20, wherein the control system is configured for controlling the programmable hologram means and the light source system to generate at least one of a sequence of holographic point light source images, a sequence of holographic line light source images or a sequence of holographic area light source images.

22. The display device of claim 20, wherein the light source system further comprises:
a second light source for producing light of a second color; and
a third light source for producing light of a third color.

23. The display device of claim 22, wherein the control system is configured for forming a frame of image data by controlling the programmable hologram means and the light source system to scan a sequence of holographic light source images across the light-turning layer.

24. A method for controlling a display device, the method comprising:
controlling a programmable hologram system and a light source system to form a first holographic light source image of a first color at a first location of a light-turning layer.

25. The method of claim 24, further comprising:
changing a pattern on the programmable hologram system to form another first holographic light source image of the first color at a second location of the light-turning layer.

26. The method of claim 24, further comprising:
controlling the programmable hologram system and the light source system to form a second holographic light source image of a second color at the first location of the light-turning layer.

27. The method of claim 26, further comprising:
controlling the programmable hologram system and the light source system to form a third holographic light source image of a third color at the first location of the light-turning layer.

28. The method of claim 27, wherein the controlling processes involve forming the first, second and third holographic light source images at substantially the same time.

29. The method of claim 27, wherein the controlling processes involve forming the first, second and third holographic light source images in a time sequence.

30. The method of claim 29, wherein the controlling processes involve forming the first, second and third holographic light source images according to a field-sequential color method.

31. The method of claim 27, further comprising:
forming a frame of image data by scanning a sequence of holographic light source images across the light-turning layer.

32. The method of claim 27, wherein the controlling processes comprise:
controlling a first programmable hologram of the programmable hologram system to form the first holographic light source image of the first color;
controlling a second programmable hologram of the programmable hologram system to form the second holographic light source image of the second color; and
controlling a third programmable hologram of the programmable hologram system to form the third holographic light source image of the third color.

33. The method of claim 27, further comprising:
controlling the programmable hologram system and the light source system to form a fourth holographic light source image of a fourth color at the first location of the light-turning layer.

34. A non-transitory computer-readable medium having software coded thereon, the software including instructions for controlling a display device to:
control a programmable hologram system and a light source system to form a first holographic light source image of a first color at a first location of a light-turning layer.

35. The medium of claim 34, wherein the software includes instructions for controlling the display device to:
control the programmable hologram system and the light source system to form a second holographic light source image of a second color at a second location of the light-turning layer.

36. The medium of claim 35, wherein the software includes instructions for controlling the display device to:
control the programmable hologram system and the light source system to form a third holographic light source image of a third color at a third location of the light-turning layer, wherein the first, second and third holographic light source images are first, second and third subpixels of a pixel.

37. The medium of claim 36, wherein the controlling processes involve forming the first, second and third holographic light source images at substantially the same time.

38. The medium of claim 36, wherein the controlling processes involve forming the first, second and third holographic light source images in a time sequence.

39. The medium of claim 36, wherein the controlling processes involve forming the first, second and third holographic light source images according to a field-sequential color method.

40. The medium of claim 36, wherein the software includes instructions for controlling the display device to:
reproduce a frame of image data by scanning a sequence of holographic light source images across the light-turning layer.

41. The medium of claim 36, wherein the controlling processes comprise:
controlling a first programmable hologram of the programmable hologram system to form the first holographic light source image of the first color;
controlling a second programmable hologram of the programmable hologram system to form the second holographic light source image of the second color; and
controlling a third programmable hologram of the programmable hologram system to form the third holographic light source image of the third color.

42. The medium of claim 36, wherein the software includes instructions for controlling the display device to:
control the programmable hologram system and the light source system to form a fourth holographic light source image of a fourth color at a fourth location of the light-turning layer, wherein the fourth holographic light source image is a fourth subpixel of the pixel.
